(19) United States
(12) Patent Application Publication
(10) Pub. No.: US 2011/0310748 A1
(43) Pub. Date: Dec. 22, 2011

(54) COORDINATOR, WIRELESS NODE AND WIRELESS COMMUNICATION SYSTEM

(75) Inventors: Kenichi MIZUGAKI, Kodaira (JP); Masaru Kokubo, Hannou (JP); Masayuki Miyazaki, Tokyo (JP)

(73) Assignee: HITACHI, LTD.

(21) Appl. No.: 13/162,568

(22) Filed: Jun. 16, 2011

(30) Foreign Application Priority Data
Jun. 17, 2010 (JP) 2010-138422

(51) Int. Cl. H04W 84/02; H04W 24/00

(52) U.S. Cl. 370/248; 370/338

(57) ABSTRACT

A wireless communication system provides high reliability wireless communications even when large scale interference affecting the entire system has occurred in ad hoc wireless communication systems. The node, access point, and intermediate nodes are each equipped with multiple wireless standards, and notify a wireless communication control device called a coordinator that sets the network communication paths with communication path information obtained by measuring the state of communication paths in the vicinity of their own respective nodes. The coordinator that now knows the communication status, issues instructions for setting plural routes using multiple wireless standards between the node and the access points as well as which wireless standard to use to implement communications between each intermediate zone, and each intermediate node conveys the measurement data while complying with those instructions.

### CLAIM OF PRIORITY

The present application claims priority from Japanese patent application JP 2010-138422 filed on Jun. 17, 2010, the content of which is hereby incorporated by reference into this application.

### FIELD OF THE INVENTION

The present invention relates to a coordinator, wireless node, and wireless communication system for same, and relates in particular to an ad hoc wireless communication device and wireless communication system for sending data from nodes by way of multiple intermediate nodes to access points.

### BACKGROUND OF THE INVENTION

The continued spread of wireless communication systems oriented toward personal uses as wireless LAN and cellular telephones has led to increased demand for wireless communications in the industrial field. In the manufacturing field for example such as in industrial plants, much equipment is currently controlled by cables. However adding a new machine requires more cable installation work in order to convey control information to this new machine. Along with the cost of the new machine, there are also expenses for cable installation work and losses from having to halt the production line during the installation period. However, if the control information could be sent by wireless then a huge reduction in costs could be attained. Achieving wireless communication in the industrial field requires attaining reliability that is the same or higher than in communication by conventional cables.

The technology disclosed in Japanese Unexamined Patent Application Publication No. 2007-195179 reveals a scheme for achieving reliability to prevent communication stoppages by utilizing route diversity to send the same data contents over multiple paths.

The technology in Japanese Unexamined Patent Application Publication No. 2008-148299 and Japanese Unexamined Patent Application Publication No. 2004-538690 attain reliability by boosting redundancy through communications by changing the code symbols for the plural paths. Moreover the Japanese Unexamined Patent Application Publication No. 2010-35068 discloses technology for switching routes according to the status of the communication path to deal with rapid fluctuations in the communication path environment.

### SUMMARY OF THE INVENTION

Wireless or radio communication of the related art includes no scheme for ensuring reliability when communication errors occur due to effects on the overall communication frequency band used for wireless communications in the area used by the wireless communication system from effects of electromagnetic noise such as from household electrical appliances, trains, industrial equipment or interference from other wireless schemes, or physical blockages due to the intrusion of objects in the communication path and so on. The route diversity method for example that conveys data utilizing plural paths (with no geographic points in common) cannot achieve sufficient reliability due to effects on all routes when a failure occurs that exerts effects on the entire communication system. Moreover even in systems that change communication parameters such as the dispersion factor and code symbols used between routes, there is still the problem of communications stoppages when a communication error occurs on the overall frequency band being used since the frequency, channels or modulation method of the wireless standard itself are not changed.

In view of these problems, an object of the present invention is to provide a coordinator and wireless communication system capable of ensuring high reliability wireless communications in ad hoc systems even when large-scale trouble occurs that effects the overall wireless standard.

A typical example of the present invention is given as follows. The wireless communication system according to one aspect of the present invention includes nodes, intermediate nodes and access points each equipped with multiple wireless standards; is further an ad hoc wireless communication system comprising at least one coordinator including a function for setting the communication route between each node and the access point; and in which a feature of the coordinator is a function to set multiple communication routes utilizing wireless standards of different frequencies and modulation methods according to the status of the communication path on the applicable communication route from the node to the access point by way of the intermediate node; and perform wireless communication between each node and the access point on the communication routes specified by the applicable coordinator, and transmit the same information from the node to the access point.

The ad hoc wireless communication system of the present invention is capable of conveying data without causing communication stoppages even in cases where a failure has occurred over a wide range spanning one entire system because the same data is jointly sent by wireless standards utilizing different frequencies and modulation methods. High reliability wireless communication matching that of cable communications can in this way be achieved while also shortening the installation period and lowering costs for installing communication cables which also allows flexible expansion of the system.

### BRIEF DESCRIPTION OF THE DRAWINGS

FIG. 1 is a concept diagram of a typical system of the first embodiment of the present invention;

FIG. 2A is a drawing showing an example of communication path status DB in the first embodiment;

FIG. 2B a drawing for describing the operation time during a communication error;

FIG. 3 is a drawing showing a typical structure of the node of the first embodiment;

FIG. 4 is a showing a typical structure of an access point in the first embodiment;

FIG. 5 is a drawing showing a typical structure of the intermediate node of the first embodiment;

FIG. 6 is a drawing showing a typical structure of the coordinator of the first embodiment;

FIG. 7 is a flow chart showing an example of system operation for the case where the packet contains routing information;

FIG. 8 is a drawing showing an example of the message flow for the case where the packet contains routing information;

FIG. 9 is a flow chart showing an example of system operation for the case where the intermediate node contains routing information;

FIG. 10 is a flow chart showing the route decision process in the first embodiment;

FIG. 11A is a drawing showing an example for setting an alternate path in the first embodiment;

FIG. 11B is a drawing showing an example for setting an alternate path in the first embodiment;

FIG. 12 is a flow chart showing the route change process in the first embodiment;

FIG. 13 is a flow chart showing the procedure for setting an alternate path during a communication stoppage in the first embodiment;

FIG. 14 is a concept diagram showing the system structure of the second embodiment of the present invention;

FIG. 15 is a concept diagram showing the system structure of the third embodiment of the present invention.

### DETAILED DESCRIPTION OF THE PREFERRED EMBODIMENTS

The wireless communication system of the present invention sets a plurality of routes between the node and the access point, and transmits data with the same contents in ad hoc communication between a node and access points by way of plural intermediate nodes in systems where the nodes, intermediate nodes and access points are each equipped with multiple wireless standards. By selecting a wireless standard according to the status of the communication paths to relay data on the respective routes, the system of this invention always conveys the communication (data) even if a large-scale communication error occurs that exerts effects over the entire communication system. The coordinator that finds that communication path status on each intermediate node, provides instructions on setting routes and wireless standards for communication by each intermediate node, and each intermediate node then conveys the information while complying with those instructions. The system of this invention moreover avoids use of redundant multiple routes between intermediate nodes and so prevents communication stoppages due to intermediate node breakdowns and blocking.

If there are plural coordinators within the same area in this system then the adjacent coordinators share data and give appropriate route instructions by having all coordinators within the same area find the status on all communication paths within the area.

Also, each intermediate node obtains the communication path status in the vicinity of its own node, and sets the optimal transfer destination and wireless standard for use to achieve route diversity utilizing multiple wireless standards without a coordinator.

The embodiments of the present invention are described next while referring to the drawings. The wireless communication standards described below are for example the IEEE802.11a system and IEEE802.11b system for wireless LAN, the ZigBee and UWE (Ultra Wideband) system, and ISA100.11a systems. Specially designated energy-saving wireless may also be utilized.

The following description assumes the sending and receiving of measurement data for temperature, pressure, gas concentrations, light and sound, etc. The ad hoc wireless communication system of this invention can in this way be applied to municipal central monitoring networks, emergency monitoring systems such as for power equipment and industrial plants, energy-saving monitor equipment, failure prediction systems at work sites, traffic facility operation management systems, building air conditioning and light control equipment, building entry/exit control systems and alarm systems etc. However, the present invention is not limited to the above applications and can also be applied to industrial equipment inside factories and medical treatment equipment such as in hospitals; all types of control actuators and position sensing and so on; and sending and receiving of machine control information.

### First Embodiment

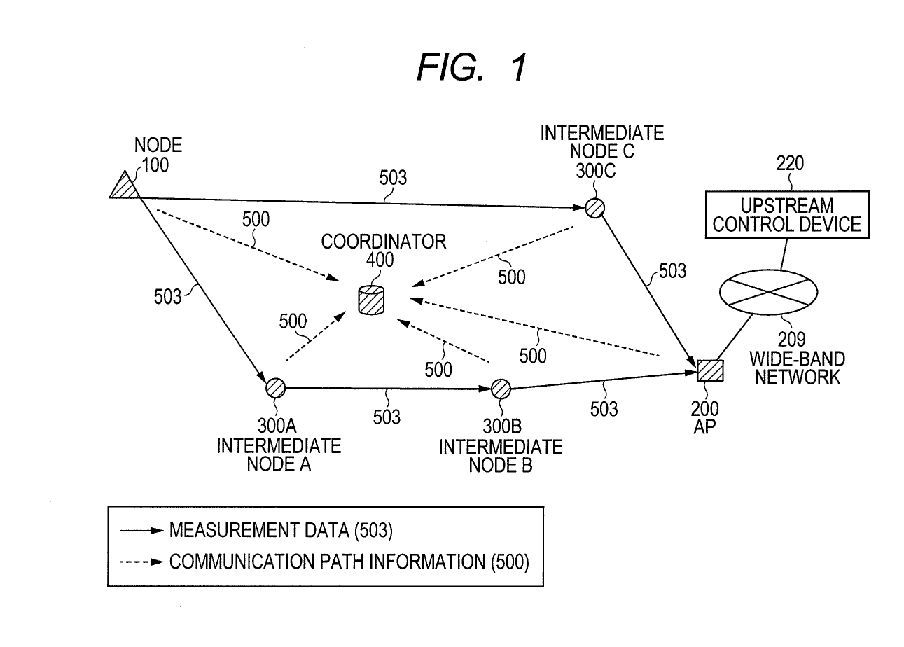

FIG. 1 shows a concept diagram of the wireless communication system of the first embodiment of this invention. This example of an ad hoc wireless communication system contains plural nodes 100 each equipped with multiple wireless standards, and at least one access point (base station) 200, multiple intermediate nodes 300, and a coordinator 400 possessing a function for setting multiple communication routes between each node 100 and the access point 200. Each node 100, access point 200, and intermediate node 300 possesses a function to measure the communication path status in the vicinity of its own node and notify the coordinator 400 of this path status. The coordinator 400 specifies communication routes (multiple repeater zones) employing plural wireless standards according to the communication status on paths (intermediate zones or repeaters) between each device, notifies each node 100 and intermediate node 300 of these routes, and then implements wireless communication simultaneous with use of multiple wireless standards on these specified communication routes.

All devices such as the node 100, intermediate nodes (300A-300C), and access point 200 within the wireless communication system contains a “communication environment measurement function” that measures and monitors the communication path status in the vicinity of its own node and sends “communication path information” 500 to the coordinator 400 if a change occurs. Other communication path parameters required by this “communication environment measurement function” are the received signal strength indicator (RSSI), and the noise power, the link quality indicator (LQI: Link Quality Identifier), the communication path effective throughput, and the latency, etc. These information items are utilized to decide if the transmission method is suitable for that communication path.

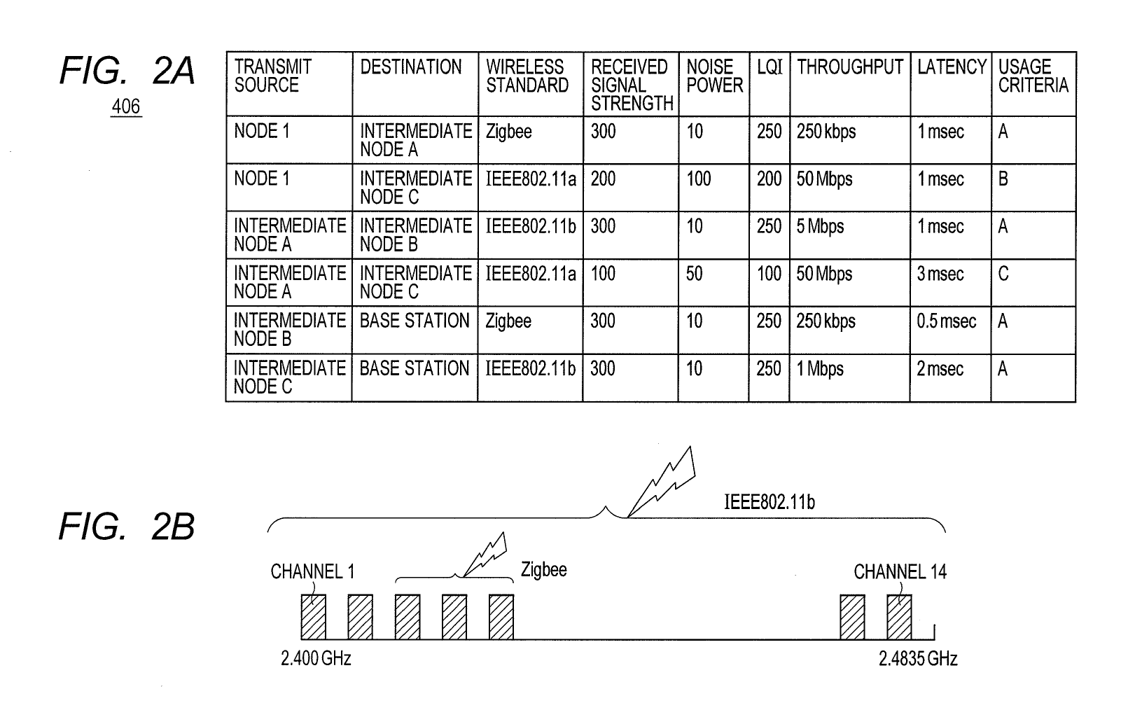

The coordinator 400 registers the reported results from this “communication path information” 500 in the communication path status DB406 as shown in FIG. 2A and utilizes these measurement results to decide the communication path. The coordinator 400 may for example decide that communication paths whose ratio of received signal power to noise power or signal-to-noise ratio (SN ratio) are lower than a fixed value are B or C, and that those paths with higher fixed values are A.

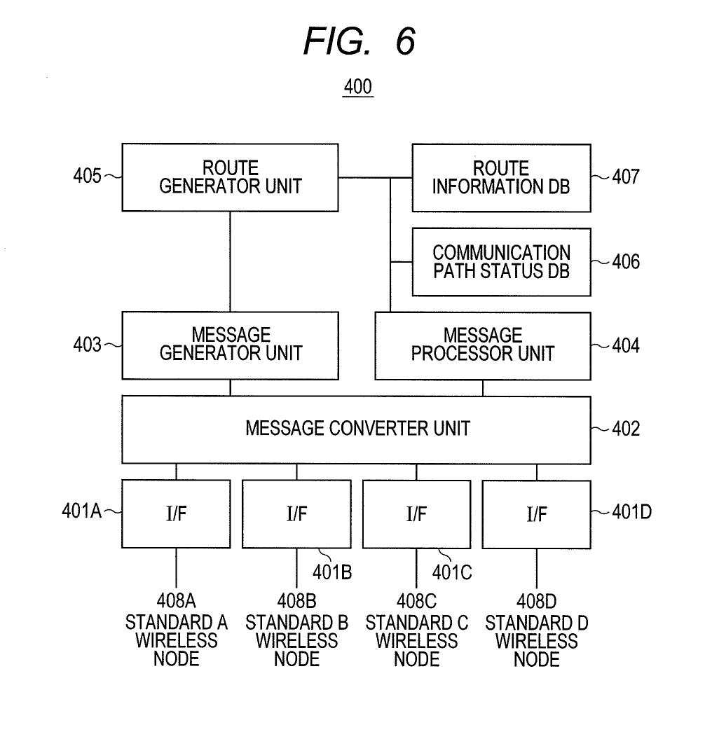

The coordinator 400 for example sets the route judged as a high-reliability A route as the communication route for usage per to the communication route status decision results, and instructs each device accordingly. The structure of the coordinator 400 including the communication path status DB406 is described in FIG. 6.

In the ad hoc communication system, the coordinator 400 constantly maintains plural routes between the node 100 and the access point 200 that satisfy the specified criteria based on the “communication path information” 500 and exerts control to allow transmitting the same data. The coordinator 400 sets plural optimal wireless standards that fully utilize the features of each wireless standard among the devices according to the status and the physical communication environment such as the relative length of the distance between the access points, the intermediate node and nodes.

When a communication error has occurred due to effects such as from electromagnetic radio waves from another wireless standard or electromagnetic noise from equipment in a state where using the ZigBee system at 2.4 GHz as shown in FIG. 2B on a route judged as a usage-criteria A communication route, then the extent of this failure may sometimes affect only a portion of channels in the frequency band used by the ZigBee system or may sometimes affect the entire frequency band. The extent of the communication error is determined according to this “communication path information” 500 so that for a communication route judged as a usage-criteria C communication route, the coordinator 400 employs another usage route judged as the A or B route that is unaffected by the communication error and has for example other channels on the same frequency band, or another frequency band, or another modulation method as the new communication route and sends corresponding instructions to each device.

The node 100 sends the measurement data 503 to the access point 200 according to the plurality of paths specified by the coordinator 400.

As one example, the access point 200 is a robot arm within the factory and the node 100 is a temperature sensor. The node 100 sends the same “measurement data” or in other words data measured by the same temperature sensor by wireless communication utilizing multiple wireless standards along plural routes at specified time periods to the access point 200. The measurement data that is sent includes information with the temperature sensor measurement time.

In the present invention, data of the same type or category measured on the same node such as data or information relating to temperature or pressure is respectively defined as the “same information” or “same data” relating to the temperature or pressure. The data rate or baud rate of the “measurement data” varies according to the wireless standard so that even if the “measurement data” relates to temperatures measured by the node 100 at specified times, there is a high probability that the data will reach the access point 200 at different times after passing through the multiple repeaters (intermediate zones). The access point 200 summarizes this plural “same data” from the different time periods into one “measurement data” such as temperature at each measurement time period and sends it over the wide band network 209 to the upstream control device 220.

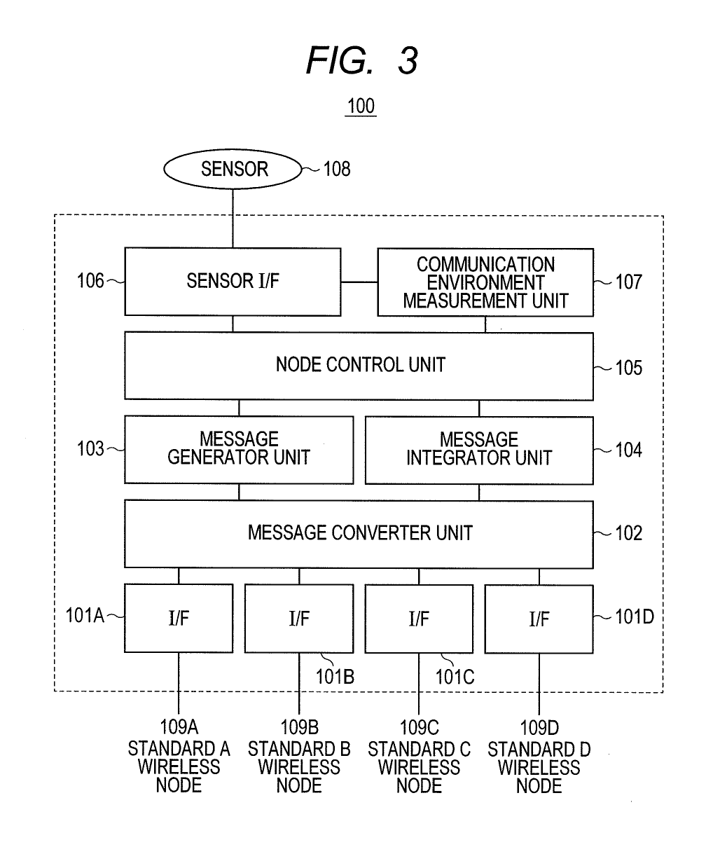

FIG. 3 shows a typical structure of the node 100. The node 100 contains a sensor I/F, 106 for connecting the sensor 108 to measure the required data; a node control unit 105 for controlling sensor measurement and communication; a message generator unit 103 for generating messages for receiving instructions from the node control unit 105 and sending sensor data and making system connections; a message converter unit 102 for converting the generated message to a format matching each wireless standard and for converting the received message to a common wireless standard format; a message integrator unit 104 for integrating messages with the same content with the messages received by the plural wireless standards; and a communication environment measurement unit 107 for measuring the communication environment in the vicinity of the node via a “communication environment measuring function”. Moreover, the node 100 is capable of connecting to plural wireless nodes (109A-109D) and contains interfaces (I/F) 101A-101D corresponding to each of the wireless nodes 109. The node 100 further contains power supplies and its control units. Executing a program stored in the memory of each microcomputer implements or controls the functions of each unit.

Examples of plural wireless standards and their carrier wave frequencies and modulation methods utilized in the wireless communication system of this embodiment include the following. The IEEE 802.11a system (or wireless standard) operates on the 5 GHz frequency band, the IEEE 802.11b system on the 2.4 GHz frequency band. In the IEEE 802.11a system, eight channels are allocated to the 5.150-5.350 GHz frequency band. In the IEEE 802.11b system a total of 14 channels are allocated at 5 MHz each in the 2.400-2.4835 GHz frequency band. The IEEE 802.11a system utilizes Orthogonal Frequency Division Multiplexing (OFDM) as the modulation method. The IEEE 802.11b system utilizes any of the Binary Phase-Shift Keying (BPSK), Quadrature Phase Shift Keying (QPSK), or the Complementary Code Keying (CCK) modulation methods to transmit the data after first diffusing the signal with Direct Sequence Spread Spectrum (DSSS) phase modulation.

The ZigBee system is utilized on the three frequency bands which of 868 MHz, 916 MHz and 2.4 GHz. On the 915 MHz band for example used by the ZigBee system, the frequency band from 902 MHz through 928 MHz is subdivided in two megahertz each and allotted to ten channels. The modulation method is Offset Quadrature Phase-shift Keying (OQPSK), and others.

The UWB (Ultra Wideband) system sends and receives over a wide frequency band from 3.1 GHz to 10.6 GHz. Amongst other systems is the NFC system that is utilized on the 13.56 MHz frequency band.

In the wireless communication system of the present invention, the coordinator 400 selects the path (plural repeaters) between each device, and one or plural wireless standards for these paths, or namely selects a combination of frequency band and modulation method as needed, and changes the combination as needed when a failure occurs to constantly maintain an optimal communication path within the system.

As shown in the example in FIG. 2B, even if a communication error occurs on the communication path during use of the ZigBee method on the 2.4 GHz frequency band, then the coordinator will switch the communication path to the wide band IEE802.11b system if already in use on the same 2.4 GHz frequency band that is unaffected by the failure and continue communication.

The node 100 directly sends a “node registration request” 501 to the coordinator 400 by way of the intermediate node 300 immediately after startup. The node 100 afterwards receives a “communication route instruction” 502 from then coordinator 400 showing the route (plural repeaters) to the access point 200. The node 100 then sends the “measurement data” 503 to the access point 200 utilizing the instructed route. The node 100 also monitors the status of the communication path environment in the vicinity of the node and if a change has occurred, sends a “communication path information” 500 to the coordinator 400. The route is changed when the coordinator 400 sends a “route change instruction” according to changes in the communication path environment in the vicinity of the node 100 and intermediate node 300.

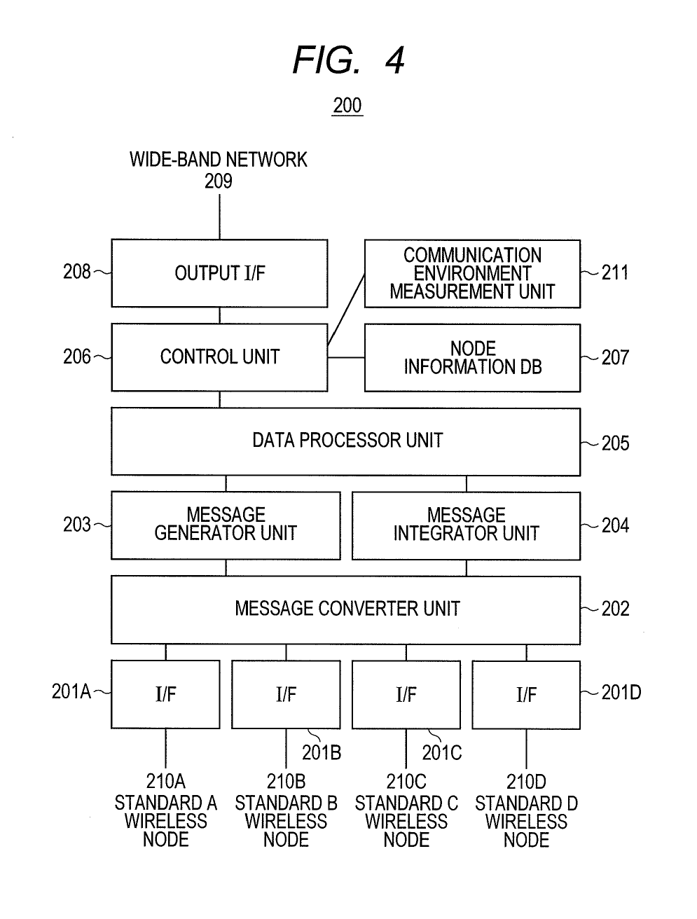

FIG. 4 shows a block diagram of the access point 200. The access point 200 is capable of connecting to the plurality of wireless nodes 210 (210A-210D) using plural wireless standards and contains interfaces (I/F) 201 (201A-201D) corresponding to these respective wireless nodes. The access point 200 further contains an output I/F208 for connecting to the wideband network 209. Moreover, the access point 200 further contains a message converter unit 202 for converting messages in all types of wireless standards received from the node 100 and the coordinator 400 into a common format or another wireless standard format; a message integrator unit 204 for integrating together messages with the same content sent along the plural paths; a data processor 205 to judge the content of messages that were sent, and process statistics and integrate the multiple measurement results as needed; and a message generator unit 203 for generating messages to send to the node and coordinator. The access point 200 further includes a communication environment measurement unit 211 to measure the communication environment in the vicinity of the access point 200. The access point 200 also includes a power supply and a node information DB207 to retain information on the node connected to its own node. A control unit 206 in the access point 200 manages the operation of all the above units. Programs stored for example in the microcomputer memory execute or control the functions of the above units.

The access point 200 provides “measurement data” 503 received from the node 100 to each external application over the network as needed. The communication environment measurement unit 211 measures the propagation path environment in the vicinity of its own node by way of the connected communication equipment and transmits the “communication path information” 500 to the coordinator 400.

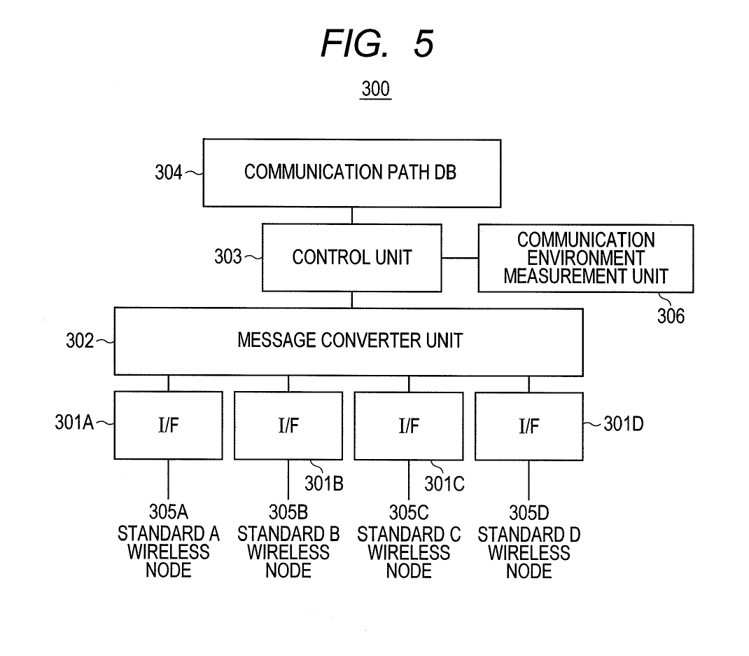

FIG. 5 shows a block diagram of the intermediate node 300 of the present invention. The intermediate node 300 is capable of connecting to wireless nodes (305A-305D) of the plural wireless standards and contains I/F 301 corresponding to the respective wireless nodes. The intermediate node 300 contains a message converter unit 302 for converting messages in each wireless standard received from the node 100 or coordinator 400 and access point 200 into a common format or another wireless standard format; a communication path DB304 for storing the transfer destination of the received messages; and a control unit 303 to control transferring of messages and measurement of the communication path environment. Moreover, the intermediate node 300 further contains a power supply and communication environment measurement unit 306 to measure the communication environment in the vicinity of the intermediate node 300. Programs stored for example in the microcomputer memory execute or control the functions of the above unit.

The intermediate node 300 forwards the “measurement data” 503 sent from the node 100 and other intermediate nodes 300 along communication paths specified by the coordinator 400. The communication environment measurement unit 306 measures the propagation path environment of its own node by way of the connected communication devices and sends the “communication path information” 500 to the coordinator 400.

FIG. 6 shows a block diagram of the coordinator 400. The coordinator 400 is capable of connecting to nodes 408 (408A-408D) of plural wireless standards and contains the I/F401 (401A-401D) corresponding to the respective nodes. The coordinator 400 contains a message converter unit 402 for converting messages in each wireless standard received from the node 100, access point 200 or intermediate node 300 into a common format or another wireless standard format. Moreover, the coordinator 400 contains a communication path status DB406 (FIG. 2A) for registering the communication path status between the node 100 and the access points 200; a message processor unit 404 for storing the contents of the “communication path information” 500 sent from the intermediate node 300 into the communication path status DB406; a route generator 405 to generate communication routes between the node 100 and the access point 200 according to the contents of the communication path status DB406; and a message generator unit 403 to generate messages for notifying the node 100, the access point 200, and the intermediate node 300 of the communication route that was generated. The coordinator 400 further contains a power supply and a route information DB407 for registering the plural selectable paths (communication routes) from the node 100 to the access point 200 by utilizing combinations of the plural wireless standards. Programs stored for example in the microcomputer memory execute or control the functions of each of the above units.

The coordinator 400 receives a “node registration request” 501 from the node 100 and sends a “communication route instruction” 502 showing the communication route from the node 100 to the access point 200 for connecting to the node 100. Moreover, the coordinator 400 judges the contents of the “communication path information” 500 sent from the node 100, the access point 200, and intermediate node 300, and sends a “route change instruction” to the node 100 when a change in the communication route is required.

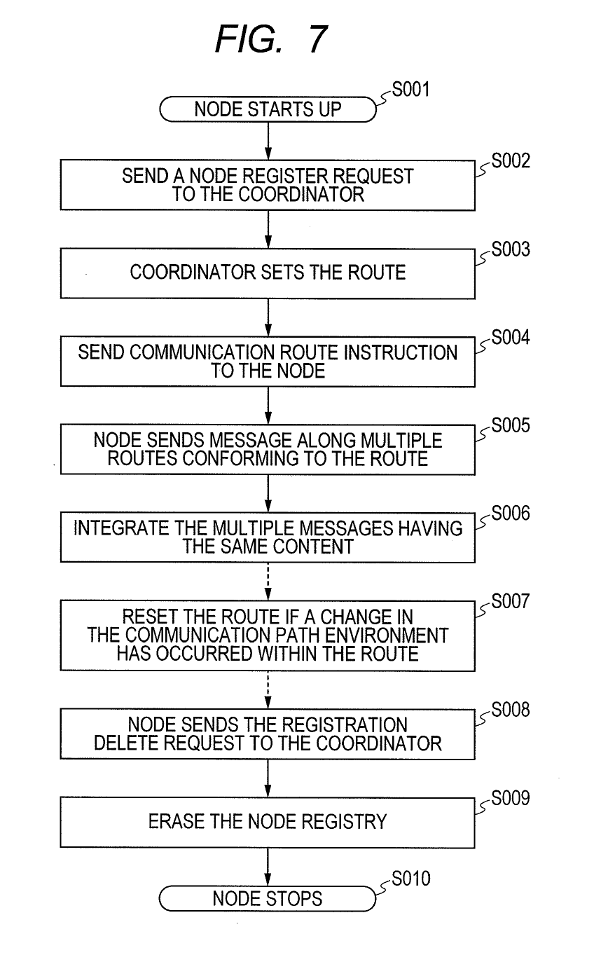

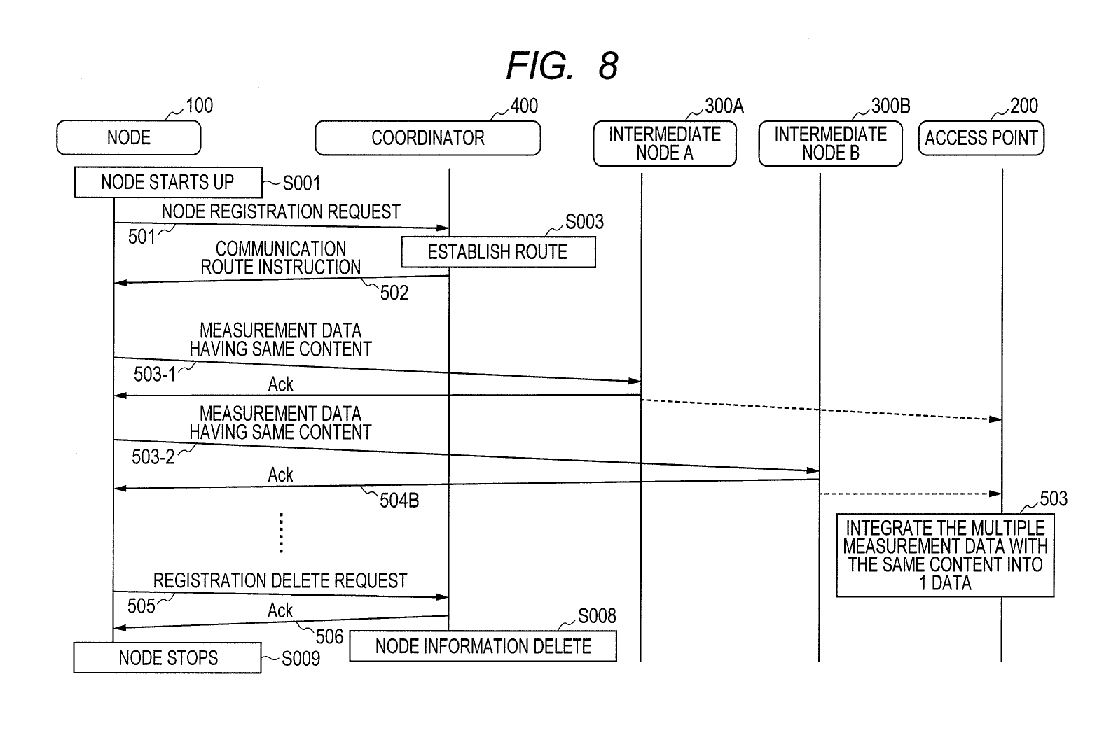

Next, FIG. 7 shows the typical operation of the wireless communication system of this embodiment. FIG. 8 shows the message flow for that operation.

The node 100 sends the “node registration request” 501 to the nearest coordinator 400 (S002) at startup (S001). At this time, instead of the node 100 sending a “node registration request” 501 directly to the coordinator 400, another method may be used where the node 100 makes a broadcast to the nearest intermediate node 300, the intermediate node 300 checks that the message content from the node 100 is a “node registration request” 501 and forwards the message to the coordinator 400. The coordinator 400 that accepted this “node registration request” 501 from the node 100, sets the access point 200 for connecting to that node 100, establishes plural communication routes linking the node 100 and the access point 200 based on the estimated node positions (S3003), and sends a “communication route instruction” 502 showing those contents to the node 100 (S004).

The communication route described here is an instruction combining the route from the node 100 to the access point 200 via the intermediate node 300; and the wireless standard used on that communication path. In one example of a route instruction for connecting from the node 100 to the access point 200 by way of the intermediate node A (300A), the instruction combines the path and the wireless standard so that communication from the node to the intermediate node A utilizes ZigBee, and communication from the intermediate node A to the access point uses IEEE802.11b. The method for establishing this route is related separately in detail.

The node 100 that received the “communication route instruction” 502 from the coordinator 400 sends the “measurement data” 503 having the same contents, along the plural specified communication routes (S005). This “measurement data” 503 contains routing information. The intermediate node 300 that received it, transfers this “measurement data” 503 from the node 100 to the access point 200 based on the routing information within the “measurement data” 503. The same contents, namely the plural measurement data 503-1, 503-2, and so on having an identical measurement time, or plural “measurement data” at different time periods due to difference in wireless standards are sent so the access point 200 checks the contents of this plural “measurement data” and integrates the same data or in other words type data having the same measurement times such as temperature to form the “measurement data” 503 (S006). The coordinator resets the route if a change has occurred in the communication path environment within the route (S007). If the node 100 has stopped operating then a “registration delete request” 505 is sent to the coordinator 400 by the same method as at startup (S008). The coordinator 400 that received the “registration delete request” 505 then deletes the communication path information relating to that node 100 (S009).

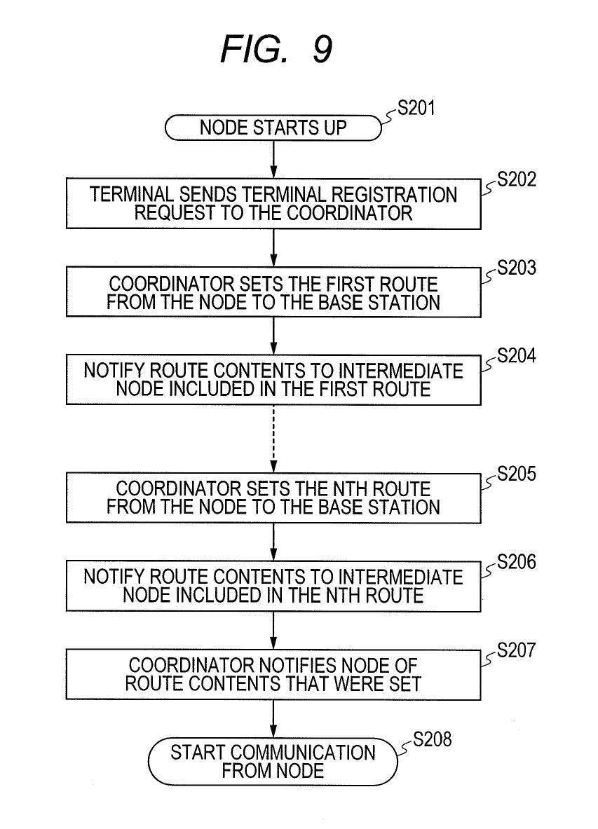

During notification of routing information to the intermediate node 300 as shown in FIG. 9, the coordinator notifies the directly related intermediate 300 of the routing information. Therefore the present invention also includes one method where the packet sent to the node 100 does not contain routing information. In other words, the node 100 makes a registration notification to the coordinator (S202) when the node 100 starts up (S201). The coordinator 400 receives this request and sets the first route (S203) from the node to the base station (access point) 200, and notifies the intermediate node included in the first route of the route contents (S204). Thereafter, the coordinator sets the Nth route from the node 100 to the base station 200 in the same way (S205), and notifies the intermediate node 300 included in the Nth route of the route contents (S206). The coordinator 400 moreover notifies the node 100 of the route contents that were set (S207), and the node 100 starts communication along this route that was set (S208).

The node 100 that received instructions for plural routes 1-N, may also divide up the data contents to send to the access point 200, and may send them along the plural routes, and sends the data; and the access point receiving the data may unify this data, demodulate the contents, and then integrate it. This process will prevent the outflow of data during the communication process.

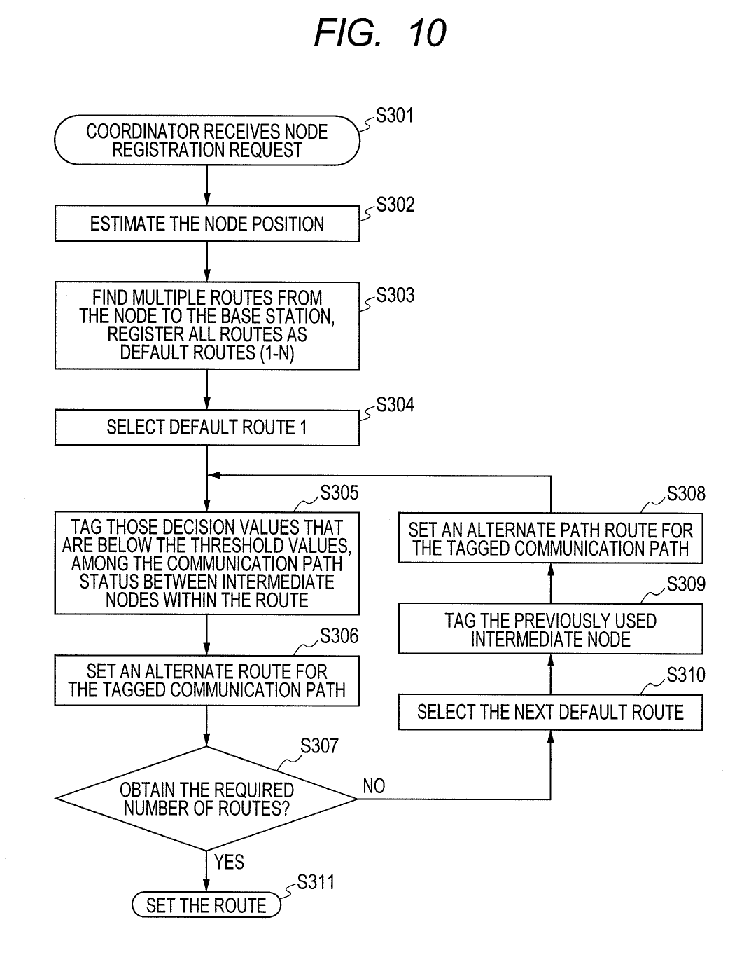

FIG. 10 next shows the procedure in the coordinator 400 for deciding the communication route. The coordinator 400 receives the “node registration request” 501 from the node 100 (S301) and first of all estimates the position of that node 100 (S302). The method for estimating the node position may for example be achieved by estimating by what combination of intermediate nodes that the signal from the node 100 was received by which intermediate node 300. In another method the coordinator 400 can estimate the node position from the signal strength of the signal from the node 100 received by the intermediate node 300 or the access point 200. The coordinator next finds plural (1-N) routes from that node position to the access point 200 (S303). One method for finding the route may be the communication path setting method for ad hoc networks described for example in Japanese Unexamined Patent Application Publication No. 2010-35068. The present invention however does not restrict the plural required routes to one route and registers all the routes unchanged into the route information DB407 for the coordinator as default routes. The default routes as referred to here are the routes connecting between the node 100 and the access point 200 regardless of the environment on the communication paths. Methods at this time include a method for setting one wireless standard for the default route, and another method that permits mixing plural wireless standards. The embodiment of the present invention includes both methods.

The number of routes set between the node 100 and the access point 200 by the coordinator 400 is an optional number set by the system administrator according to the environment where the node 100 is installed. The number of routes may be increased or decreased according to the priority of data sent from the node 100.

To set up a route between the node 100 and the access point 200, the coordinator 400 first of all selects one default route from the route information DB407 (S304). The information on the communication paths included in this default route are checked by the communication path status DB406, and after a usage judgment process, is registered and rewritten in the communication path status DB406, and a communication path whose judgment values fall below a fixed standard value are tagged (S305). The system sets criteria values according to the priority of the communications.

Examples of criteria values for judging and selecting whether or not the wireless standard is suitable for that communication path are given as follows. The route generator 405 selects a wireless standard that simultaneously satisfies any one or plural conditions in these examples as a wireless standard suitable for the communication path.

(1) Received signal power that is higher than a specified value.
(2) Noise power that is lower than a specified value.
(3) Packet error rate that is lower than a specified value.
(4) Propagation delay is smaller than a specified value.
(5) Signal power to noise power ratio (SN ratio) is larger than a specified value.
(6) The differential between the number of sent packets and number of Ack signals for those packets is smaller than a specified value.

The communication path status DB406 next searches for another communication path as a substitute for the tagged communication path (S306).

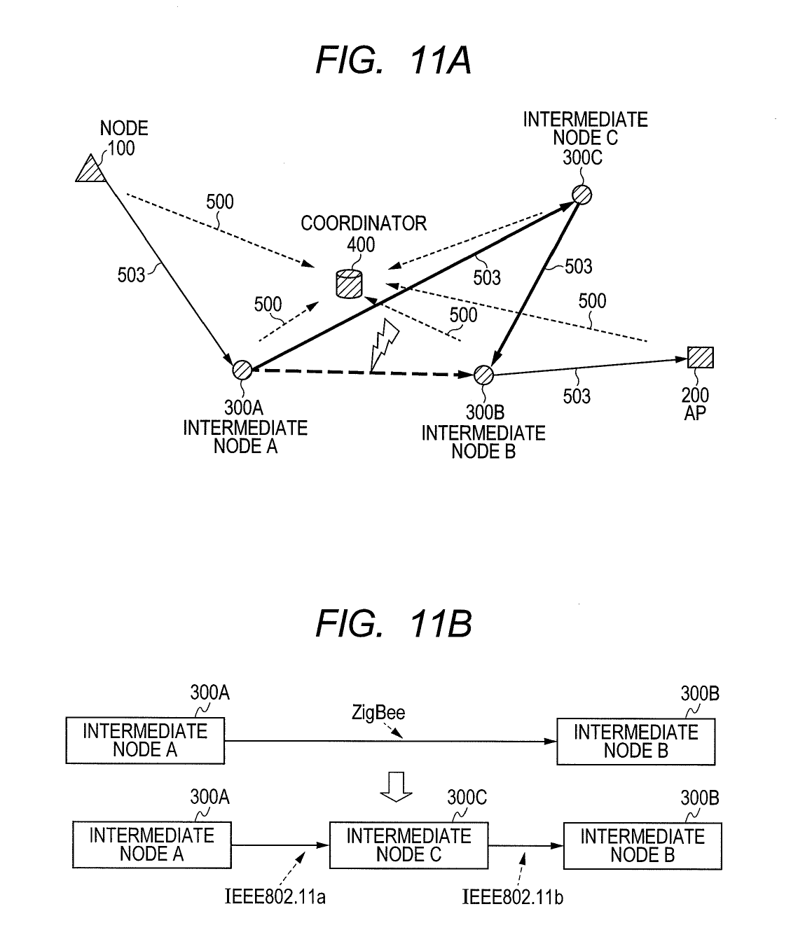

When a communication error occurs for example due to a problem along the communication path joining the intermediate node 300A and intermediate node 300B as shown in FIG. 11A, then that communication path is assumed as a case where the judgment values on that communication path are lower than the criteria values based on the “communication path information” 500 sent from the intermediate node 300B.

The route generator 405 for the coordinator 400 in this case searches the default routes stored in the route information DB407, and decides on utilizing a detour route combining communication paths where IEEE802.11a joins the intermediate node 300A and the intermediate node 300C; and IEEE802.11b joins the intermediate node 300C and the intermediate node 300B as a combination detour route as a default route that is substitutable and satisfies the above criteria values for the communication paths using ZigBee to join the intermediate node 300A and intermediate node 300B. If a substitute path can be set in the same way for all tagged communication paths then this substitute path can be set as a single route from the node 100 to the access point 200.

The coordinator 400 next selects another default route from the route information DB407 (S310). Communication paths included among the previously set routes are tagged for this communication path (S309). The coordinator 400 sets alternate paths for these tagged communication routes in the same way (S309), and also checks the information included in these routes on the communication path status DB406, and tags communication paths whose judgment values are below a fixed standard value (S305). The coordinator 400 also sets an alternate communication path for these (tagged) routes in the same way (S306), and moreover repeats this task until the required number of routes has been obtained (S307).

After obtaining the required number of routes, the coordinator 400 notifies the node 100 of those contents in the form of a “communication route instruction” 502 (S311).

Moreover when the coordinator 400 sets the route, the plural intermediate nodes 300 that initially receive transmissions from a certain node 100 may be set on the plural routes in directions as seen from that node 100 that are greater than a specified angle so that even if an incident occurs that blocks a portion of the vicinity of that node 100 due to an obstruction or problem then the communication will not be completely cut off.

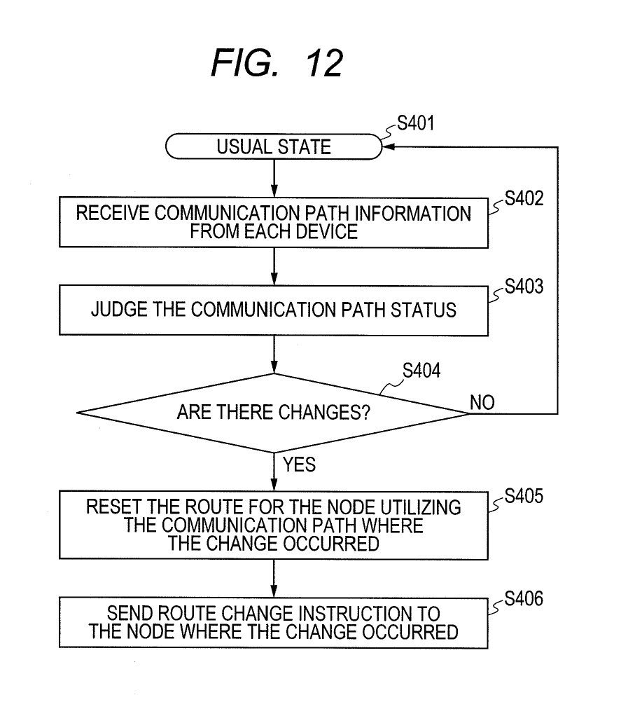

The route change procedures used when a change has occurred along the communication path within the route are described next while referring to FIG. 12. The status along the communication paths for each node, access point, and intermediate node is constantly monitored and if a change has occurred then a “communication path information” 500 report is made to the coordinator. After receiving the communication path information (S402), the coordinator 400 registers those contents in the communication path status DB406, and makes a further judgment of the status on the communication path where the change occurred (S403). During usage of this path and when also decided that a problem has occurred in maintaining communications, the route generator unit 405 searches plural default routes that satisfy the criteria values registered in the route information DB407, establishes a new route by utilizing the substitute communication paths for this communication path (S405), and sends a “route change instruction” to the node 100 (S406). The node 100 receives the “route change instruction” and communicates by way of the new route using any of the plural wireless node standards. Utilizing plural communication paths within the system essentially avoids a communication stoppage and achieves wireless communication with high reliability equivalent to that of cable communications.

One more method that may be employed at this time when there are no suitable alternate paths within the applicable communication system due to reason such as occurrence of a large communication error is temporarily switching over data transmission to a public communication system or a separate communication system, and then resetting the route when the system recovers from the failure.

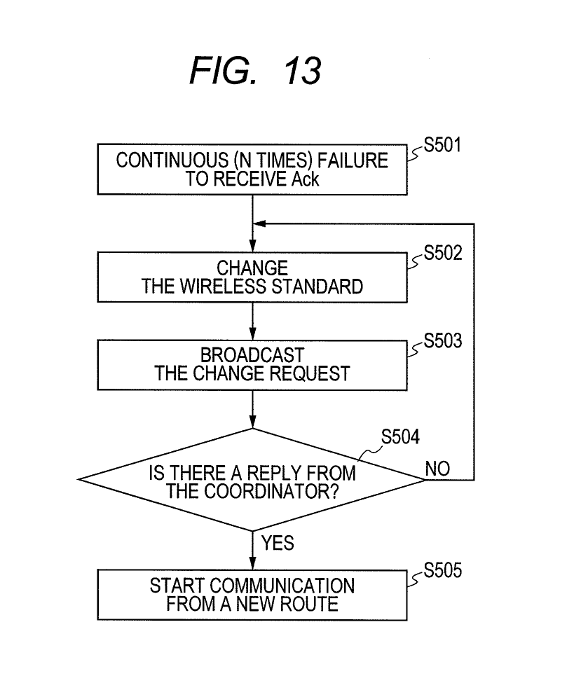

The processing used when a communication stoppage has occurred between the node 100 and the intermediate node 300 or between the node 100 and the access point 200 is described next using FIG. 13. If the node 100 did not continuously receive an Ack signal from the transmit destination within a specified number of times (S501), then the node 100 decides there is a communication interruption or stoppage. The node 100 then selects a wireless standard different from that used in communications up till this time (S502), and makes a “communication route change request” broadcast containing the status of the communication path stoppage to the peripheral coordinators 400 (S503).

The node 100 may at this time send the broadcast to the coordinator 400 by way of the intermediate node 300 and access point 200 without sending the broadcast directly to the coordinator 400.

The coordinator 400 searches the default routes registered in the route information DB407 and sends a “route change instruction” to the node 100 to set an alternate path for the communication path where the problem occurred. The node 100 then communicates on that new route (S505) after receiving the “route change instruction” from the coordinator 400. If the node has not received a “route change instruction” within a specified period after sending the “route change request” then the wireless standard is changed and sends the “route change request” again. The node repeats this process until a route change instruction is received.

The present embodiment therefore is capable of configuring a wireless standard capable of sending the same data that can be jointly utilized on wireless standards having different frequency bandwidths and modulation methods and sent simultaneously along plural paths, even when a wide-scale failure has occurred that effects not only a portion but the entire wireless communication system. This embodiment can therefore continuously transmit data without causing a communication stoppage even if a wide-scale failure occurs. This embodiment can moreover also achieve wireless communication with high reliability equivalent to that of cable communications. Moreover, this embodiment is a wireless method so the cost of installing communications cable is reduced and the construction period for the installation can be significantly shortened. Another advantage is that flexible system expansion can be achieved.

### Second Embodiment

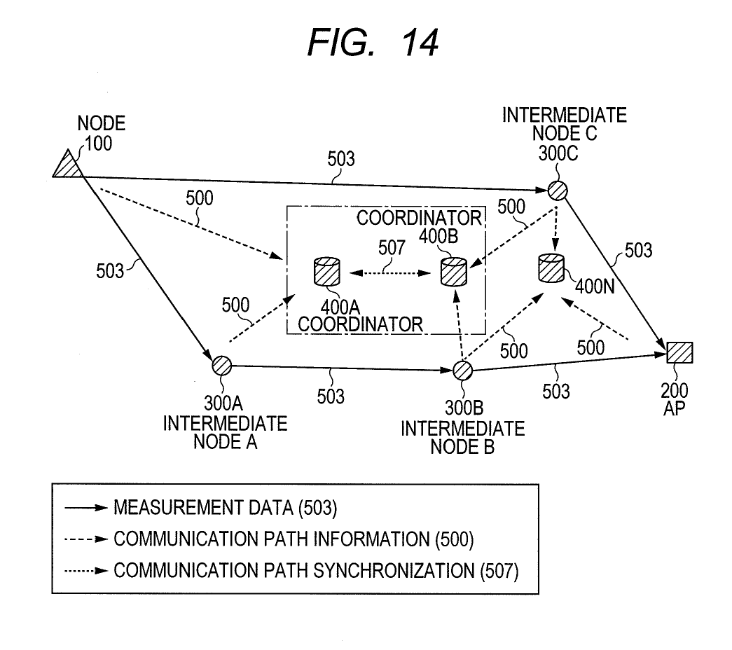

FIG. 14 shows the configuration of the second embodiment of the wireless communication system of the present invention. The system of the second embodiment contains plural coordinators A, B, N (400A, 400B, 400N). During the initial setting, all of the intermediate nodes 300 are registered non-redundantly in the nearest coordinator 400. Adjacent coordinators 400A, B can exchange communication information relating to route and communication path status directly or indirectly by way of the intermediate nodes 300 on the “communication path synchronization” 507 so that all the coordinators 400 (A, B, N) can share the same route information DB407 and communication path status DB406. During registration of the node 100, the number of intermediate nodes 300 required for the information to arrive at the node 100 during registration is compared among all the coordinators 400, and the coordinator 400 utilizing the fewest number of intermediate nodes 300 handles the setting and the changing of the route for the node 100. In other words, all the coordinators 400 jointly utilize communication path information having the same content, and the coordinator 400 utilizing the fewest number of intermediate nodes to a certain node 100, handles the setting and changing of the route based on this communication path information.

The present embodiment sends data to plural intermediate nodes 300 the same as in the first embodiment, and ultimately the “measurement data” 503 is simultaneously transferred over plural routes to the access point 200. This second embodiment configures a wireless communication system capable of simultaneously sending the same data along plural paths by jointly utilizing another wireless standard having different frequency bandwidths and modulation methods, and therefore the data can be transmitted without causing a communication stoppage even when a wide-scale failure has occurred. This embodiment can therefore achieve wireless communication with high reliability equivalent to that of cable communications. Further, all the coordinators 400 share the same communication path status content so communication between the node 100 and the access point 200 is possible even over long distances and over a wide range. The embodiment can also select the ideal route from many potential routes. In addition even if a failure occurs on any one of the coordinators 400, the other coordinators can maintain those functions.

### Third Embodiment

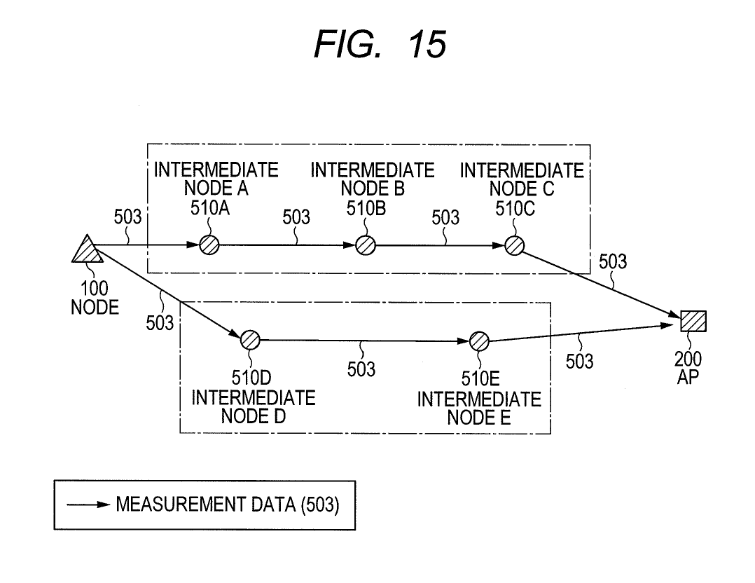

FIG. 15 shows the configuration of the third embodiment of the wireless communication system of the present invention. In this third embodiment there are no coordinators within the system. Instead, the wireless nodes that comprise the plural intermediate nodes 510 (A-E) within the system possess functions equivalent to the coordinator. Namely, each wireless node 510 contains a route information DB, and estimates the node 100 position, finds plural routes connecting between the node and the access point by different wireless standards regardless of the communication path status, and registers all these routes in the route information DB as default routes (routing information). The node 100, access point 200 and each wireless node (intermediate node) 510 possess communication environment measurement functions for measuring the communication path status on communication routes in the vicinity of its own node. The parameters for the communication path measured by these communication environment measurement functions include at least any one among received signal power strength (intensity), noise power, link quality, effect throughput on communication path, and latency parameters. Each of the wireless nodes 510 sets a wireless standard for use and for the transfer destination of the message sent from any of the nodes 100 based on routing information of adjacent intermediate nodes, and the access point 200, and its own measured communication path information and transfers the “measurement data” 503. Each wireless node 510 decides whether use of another communication path is possible, and if decided the path is not suitable for use, it then by itself establishes an alternate communication path to adjacent intermediate nodes, and transfers the “measurement data” 503.

The node 100 sends data towards the plural intermediate nodes 510 the same as in the first embodiment and ultimately transfers the “measurement data” 503 simultaneously over plural routes to the access point 200. During data transfer if one intermediate node 510 received the same data two or more times along different routes, then it attached information indicating the information was already included in other routes and sends the message back to the intermediate node that was the transmit source. The intermediate node the received the returned message then selects another communication path and once again transfers the data

This embodiment is therefore capable of configuring a wireless communication system capable of simultaneously sending the same data on plural paths by jointly utilizing separate wireless standards having different frequency bandwidths and modulation methods, and is moreover capable of continuously transmitting data without causing a communication stoppage even if a wide-scale failure occurs. This embodiment can therefore achieve wireless communication with high reliability equivalent to that of cable communications. Moreover, communication is achievable over a wide range without coordinators.

What is claimed is:

1. A wireless communication system for ad hoc wireless communication systems comprising: nodes, intermediate nodes, and access points each equipped with a plurality of wireless standards and further comprising at least one coordinator having a function for setting the communication route between each node and the access point,
wherein the coordinator has a function to set a plurality of communication routes utilizing wireless standards including different frequencies and modulation methods according to the communication path status on the applicable communication route by way of the intermediate node from the node to the access point, and
communicates by wireless between each node and the access point on the communication routes specified by the applicable coordinator, and transmits the same information from the node to the access point.

2. The wireless communication system according to claim 1,
wherein the nodes, access points, and intermediate nodes each have a function to notify the communication path status of the communication route in the vicinity of its own node as communication path information to the coordinator; and
wherein the coordinator has a function to specify the communication routes combining different wireless standards satisfying specified criteria in intermediate zones between the node and the intermediate node based on the communication path information.

3. The wireless communication system according to claim 1,
wherein the nodes, intermediate nodes, and access points are each equipped with different wireless standards, and
wherein the coordinator sets the communication route from the node by way of the intermediate zones to the access point based on communication path information relating to the communication path status, and decides what wireless standard to use to communicate at each intermediate zone.

4. The wireless communication system according to claim 3,
wherein the coordinator sets communication routes so that the same intermediate nodes are not redundantly used between the communication routes, and
wherein the access point checks the contents of the information received from the node, and integrates plural information with the same contents received by way of the communication routes into a single information.

5. The wireless communication system according to claim 3,
wherein the coordinator estimates the node position, finds the routes connecting between the applicable node and the access point by different wireless standards regardless of the communication path status, and registers all the applicable routes in the route information database as default routes.

6. The wireless communication system according to claim 5,
wherein the default route includes one wireless standard or a mixture of plural wireless standards, and
wherein the number of default routes is set in advance according to the important degree of the information sent from the node.

7. The wireless communication system according to claim 5,
wherein the coordinator selects a specified number of default routes satisfying specified criteria values from among default routes retained in the route information databases based on the communication path information, and then specifies or updates the default routes as the communication route.

8. The wireless communication system according to claim 5,
wherein to establish the communication routes, the coordinator sets plural routes so that the intermediate nodes where data is first sent by the node are in different directions the same or larger than a fixed angle.

9. The wireless communication system according to claim 1,
wherein the node, the access point, and the intermediate node has a communication environment measurement function that measures and the communication path status in the vicinity of its own node, and
wherein communication path parameters measured by this communication environment measurement function include at least one from among the received signal power, noise power, link quality, effective throughput on the communication path, and latency.

10. The wireless. communication system according to claim 1, comprising a plurality of the coordinators,
wherein the node, the access point, and the intermediate node have a function to measure the communication path status in the vicinity of their own node and notify this communication path status of the nearest coordinator as the communication path information,
wherein all the coordinators can share communication path information having the same contents by sharing the communication path information that was received by the adjacent coordinators, and
wherein the coordinator sets the routes using wireless standards according to the communication route status based on the shared communication path information.

11. A coordinator for an ad hoc wireless communication system comprising nodes, intermediate nodes, and access points each equipped with a plurality of wireless standards,
wherein the coordinator has a function for setting a communication route between each node and the access point,
receives notification from the node, the access point, and the intermediate node relating to communication path information on the communication routes on the periphery of their own nodes, and
has a function for setting plural communication routes utilizing wireless standards of different frequencies and modulation methods, as communication routes from the node by way of the intermediate nodes to the access point based on the communication path information.

12. The coordinator according to claim 11,
wherein the wireless communication system includes the coordinators,
wherein each of the coordinators receives notification from the nearest node, the access point, and the intermediate node relating to communication path information on the communication routes on the periphery of their own nodes,
wherein each of the coordinators can share communication path information having the same contents by sharing the communication path information mutually received by adjacent coordinators, and
wherein each of the coordinators sets the route utilizing wireless standards according to the communication route status based on the shared communication path information, and notifies the nearest node or the intermediate node of the route.

13. The coordinator according to claim 11,
wherein the coordinator includes a route information database, and estimates the node position, finds plural routes connecting between the applicable node and the access point by different wireless standards regardless of the communication path information, and registers all of the found routes in the route information database as default routes.

14. The coordinator according to claim 13,
wherein the communication path information notified to the coordinator by the node, the access point and the intermediate node, includes at least one among the received signal strength, noise power, link quality, effective throughput on the communication path, and latency as communication path parameters, and
wherein the coordinator selects a specified number of default routes satisfying specified criteria values from among default routes retained in the route information database satisfying the specified criteria values based on the communication path information, and then specifies or updates the default routes as the communication routes.

15. The coordinator according to claim 14,
wherein the criteria used by the coordinator to select a wireless standard for the communication path are a high received signal power or a low noise power.

16. The coordinator according to claim 14,
wherein the criteria used by the coordinator to select a wireless standard for the communication path are a low packet error rate or a low propagation delay.

17. The coordinator according to claim 14,
wherein criteria used by the coordinator to select a wireless standard for the communication path is a large signal-to-noise ratio or that the differential between the number of sent packets and number of Ack signals for those packets is smaller than a specified value.

18. A wireless node of an ad hoc wireless communication system comprising nodes, a plurality of wireless nodes each functioning as intermediate nodes and access points all equipped with a plurality of wireless standards,
wherein each of the wireless nodes has:
a function to measure the communication path status in the vicinity of its own node;
a function to set plural communication routes utilizing wireless standards possessing different frequencies and modulation methods as the communication route from the node by way of each wireless node to the access point; and
a function to select an optimal communication route and wireless standard from the plural wireless standards according to the communication path status and to implement ad hoc communication of the same information contents on plural paths between the node and the access point.

19. The wireless node according to claim 18,
wherein the wireless node estimates the node position, finds plural routes connecting between the applicable node and the access point by different wireless standards regardless of the communication path status, and registers all the routes in the route information database as default routes, and
selects a specified number of default routes satisfying specified criteria values from among default routes retained in the route information database based on the communication path information, and then specifies or updates the default routes as the communication route.

20. The wireless node according to claim 19,
wherein the wireless node has a communication environment measurement function that measures the communication path status of the communication route in the vicinity of its own node, and
wherein the communication path parameters measured by this communication environment measurement function that include at least one from among the received signal power, noise power, link quality, effective throughput on the communication path, and latency, and
selects a specified number of default routes satisfying specified criteria values from among default routes retained in the route information database based on the communication path information, and then specifies or updates the default routes as the communication route.
